(19) United States
(12) Patent Application Publication
(10) Pub. No.: US 2009/0158980 A1
(43) Pub. Date: Jun. 25, 2009

(54) SEEDING ASSEMBLY IN GRAIN SEEDING MACHINES

(76) Inventors: Castagno Manasseri, Salinas (UY); Reymund Poggio, Salinas (UY)

Correspondence Address: COLLEN IP, THE HOLYOKE MANHATTAN BUILDING, 80 SOUTH HIGHLAND AVENUE, OSSINING, NY, 10562, US

(21) Appl. No.: 12/340,059

(22) Filed: Dec. 19, 2008

(30) Foreign Application Priority Data
Dec. 20, 2007 (UY) 30828

(51) Int. Cl. A01B 49/06

(52) U.S. Cl. 111/139

(57) ABSTRACT

A seeding assembly in grain seeding machines, in which the position of the elements is modified and some of them are redesigned; which includes an articulation hinge kind of mechanism in association with the seeding movement, minimizing the entry of vegetable residues, dust, moist soil, etc., simplifying release thereof, and providing efficient and prompt cleaning with the purpose of reducing detention time of the machine.

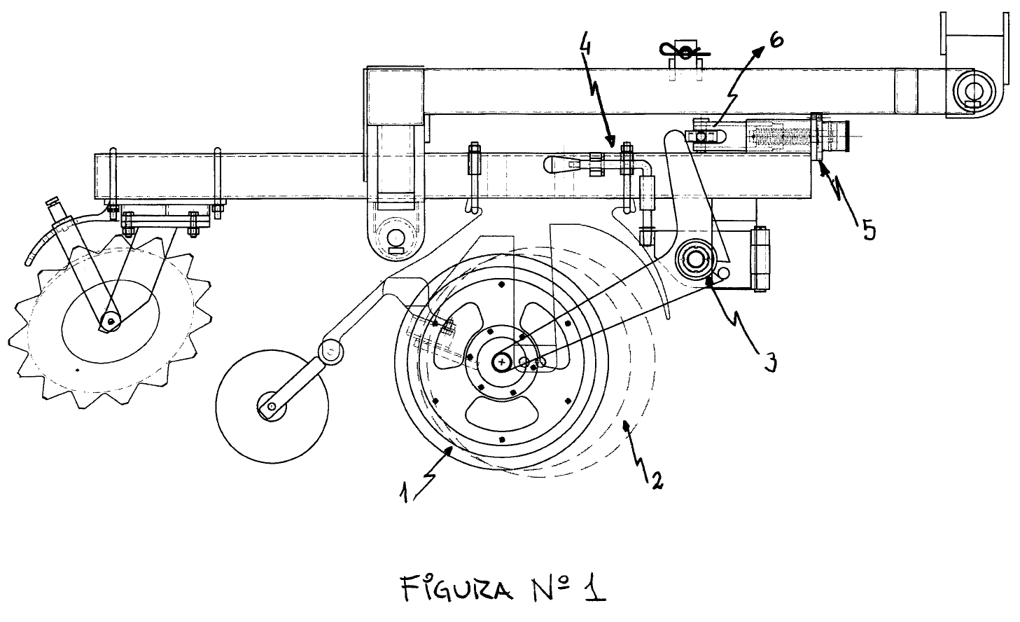

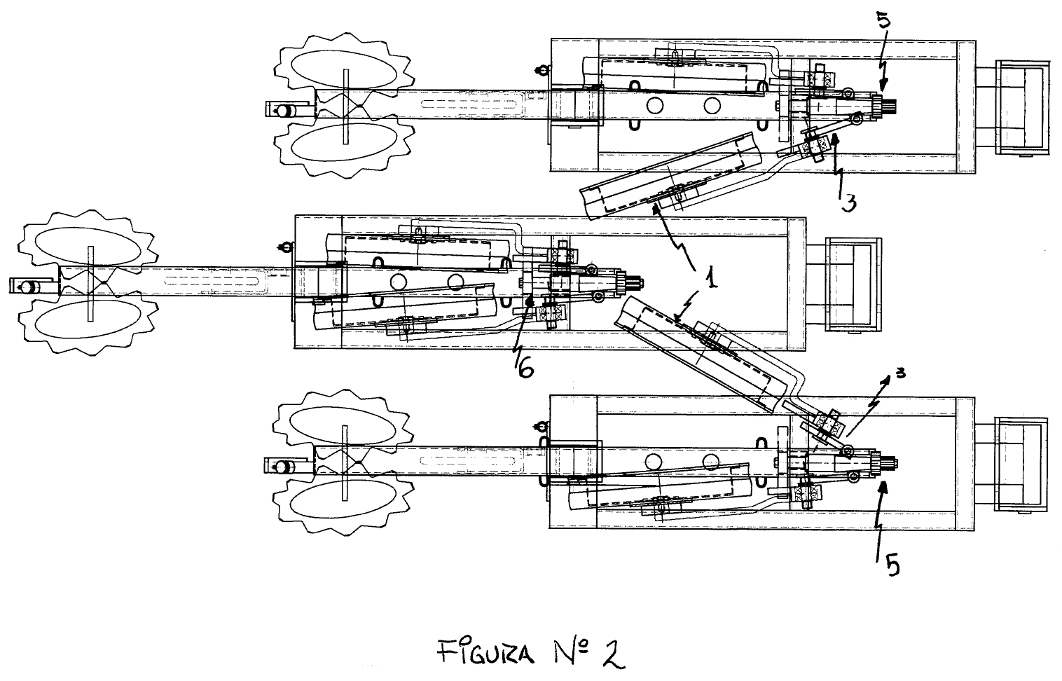

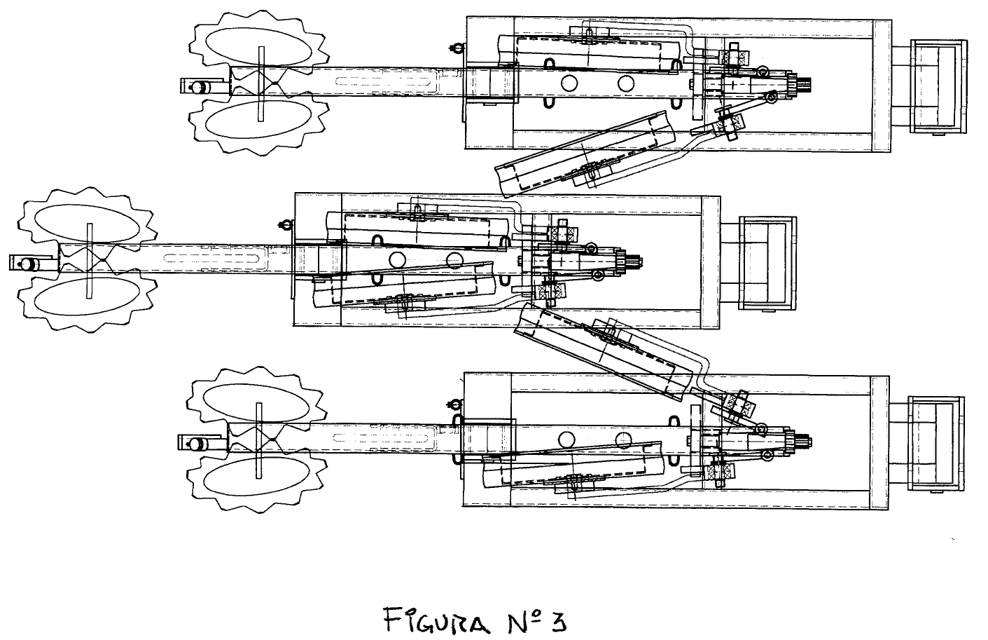

### 1. BACKGROUND OF THE INVENTION

This invention describes a seeding assembly in grain seeding machines, more precisely, a seeding assembly with a hinge mechanism in the front part of the assembly, that brings closer and separates the depth control wheel from the opener disk, the main effect of which is to minimize the entrance of vegetable residues, dust and moist soil, aiding expulsion thereof, and providing an efficient and prompt cleaning to avoid longer detention time of the machine.

This innovation originates from the constant improvement searched on grain seeding machines, particularly, those used for so-called direct seeding or no-till seeding.

Moreover, Argentinean registrations of Invention Patents, belonging to the firm named Avec S.R.L, such as:

No. 247466—Dispositivo óleo-neumático de control de cargas (Oil pneumatic load control device)

No. 249176—Mejoras en un dispositivo óleo-neumático de control de cargas (Improvements on an oil-pneumatic load control device)

No. 250967—Conjunto articular de brazo principal y balancin (Joint assembly of main arm and balance beam)

are the references based on which, upon constant operation development and improvement, the present innovation is produced.

Before description of the invention there is a brief description of the background references.

The Oil-pneumatic Load Control Device, together with the Balance Beam System, provides exact regulation of the preset loads as a function of the soil to be seeded. The loads are therefore kept constant at all times, regardless of the unevenness of the soil. Therefore, a constant load combined with the perfect tracing of the soil guarantees uniformity in seeding depth followed by the appropriate covering.

The problem associated to this study is a result of the obstruction with vegetable residues, dust or moist soil, which enter among some of the components of the so called “seeding assembly” or “seeding train”.

The development of this invention is inspired on the arrangement of the known seeding assembly elements, the fact that said assemblies are rigidly conformed, and the poor adaptability for their self cleaning or evacuation of the vegetable residues, dust, etc. The object of this invention is to improve adaptability of the assembly, achieve an easy and correct evacuation of the accumulated residues and provide to the user of the seeder higher effectiveness, work efficiency, and most importantly, avoids longer detention time caused by obstruction of the seeding assembly.

### 2. SUMMARY OF THE INVENTION

Generally seeding assemblies include the following:
a) A device to open the furrow, usually composed of one or two flat disks (single disk, double disk), or composed of a kind of spike or hoe;
b) A device to place the seed in the bottom of the furrow, generally consisting of a rigid tube set between both disks or on the side of the single disk;
c) A device to place fertilizer in the bottom of the furrow, generally consisting of a rigid tube set between both disks or on the side of the single disk (this is what commonly occurs when fertilization and seeding take place simultaneously).
d) A device to control depth of the seed in the furrow; this may be carried out by rings laterally attached to one of the furrow disks (or to the single disk), or either by one or two wheels with rubber tires; in the case of rings, the different depths are regulated by varying the size (diameter) of the rings; whereas in the case of wheel(s) there is a specifically designed mechanism for said regulation of depth;
e) A device to close the furrow, which usually consists of one or two wheels with rubber tires; it is common to attach thereto serrated disks;
f) There are some designs which also include a device which presses the seed against the furrow walls, after said seed has been placed therein and before closing the furrow; generally said device is a metal wheel or it includes a rubber or plastic tire.

The above mentioned elements are placed on a beam, generally a straight one, ordered in such a way they operate with the correspondent sequence (furrow opening up to certain depth; placing of the seed and fertilizer; seed pressing; furrow closing).

The present invention describes a new arrangement of the elements available in “seeding assembly or seeding train”. Said new arrangement not only improves and provides better efficiency to the work on general terms, it also perfects the depth control system, provides adaptability to the assembly, and moreover, innovates the mechanism, providing regulation and articulation which improves self cleaning of its elements; by both diminishing the amount of residues entering the assembly and providing to said residues an easy way out of it.

Summarizing, the assembly herein introduced, achieves, by means of its new arrangement and modification of the elements, a more efficient operation, improvement of the depth control system and simplification of the cleaning of the assembly through the new arrangement of its regulation and articulation of the mechanism.

### 3. BRIEF DESCRIPTION OF DRAWINGS

Drawing No. 1—Side view of the assembly.

Drawing No. 2—Upper view with maximum opening of the depth control wheels.

Drawing No. 3—Upper view with partial opening of the depth control wheels.

### 4. DETAILED DESCRIPTION OF THE INVENTION

The innovation presented herein develops from the complications, which have been observed, and which are associated to the practical use of the grain seeders in general.

However, particularly we refer to the seeder which applies the oil-pneumatic device patented under number 247466, which produced the first modification or improvement in patent under number 249176 “Improvements on an oil pneumatic load control device . . . ” which was finally modified in patent under number 250967 “Joint assembly of main arm and balance beam, applied to agricultural machines”.

In said invention patent (250967) the elements of the joint assembly are described, featuring a main arm, on one end articulated to the machine frame, on the other end articulated to a support projected underneath thereof, inside which there is an area crossed by the balance beam, the latter articulated to spin in a transversal shaft which is provided in the bottom end of said second support; the balance beam is joint to the furrow opener disks through a connecting piece fixed to the end of the balance beam, whereas the covering wheel which is part of the arrangement, is fixed—by means of sliding mounted clamps—in adjustable position on the side of the balance beam opposite to the referred second articulated support.

One of the objects of the present invention is the new design of the depth control system, which improves its functionality. Moreover, the new arrangement and modification of the present invention minimizes the entrance of elements, such as vegetable residues, dust, moist soil, etc., into the available area between the wheel and the disk, in turn improving evacuation of the few elements that enter the assembly.

A further improvement applied to the invention is the conformation of a mechanism, with provides, firstly, regulation of the seeding depth and, secondly, articulation of the elements of the mechanism, achieving minimized detention times of the machine for cleaning the seeding assemblies.

With the purpose of enlightening the invention, which is defined as “Seeding assembly in Grain Seeding machines”, for its simple application, its preferred aspects shall be described in the following sections, through the attached descriptive drawings. The purpose is to describe without limitation the invention, the components of which may be selected from different equivalents, without departing from the invention principles defined in the present document.

According to Drawing No. 1, the depth control wheels (1) may be located in the front or rear of the furrow opener disks (considering the running direction of the seeder and thus of the seeding assemblies).

The wheels are located in the front part of the disks. A closer location of the wheels from the disks (2), improves efficiency of the wheel's function. In the presently known designs, the wheel tire includes a kind of “lip” in the face in contact with the disk, to achieve proper contact between the side face of the disk and the side face of the wheel tire. The contact between these two faces should be permanent, whatever the position of the wheel with the disk (higher or lower position, depending on the necessary depth), also considering the dynamic of the seeding operation in general terms and of the no-till seeding in particular, which is carried out on vegetable residues or coverings and this causes the same to be introduced into the area between the wheel and the disk, usually together with dust and moist soil. This causes the above mentioned problems, such as reduced operative performance of the machine, due to the frequent detention of the operation for cleaning seeding assemblies, which in some cases even prevents proper seeding.

These problems have originated the necessity to redistribute elements and to improve the previous design, taking into account these difficulties perceived during field work.

The present invention is a mechanism, based mostly on Invention Patent No. 250967 “Joint assembly of main arm and balance beam . . . ”, in which the new arrangement of the elements provides a simple cleaning of the area between the wheel and the disk, minimizes the detention time of the machine, achieves better regulation of the seeding depth and introduces a hinge joint (3) of Drawing No. 1, so that the dynamic of the forces involved in the seeding task tends to press the side face of the rubber tire against the disk face (Drawing No. 2), and thus separation between the two faces is minimal; this situation is unaltered whatever the position of the wheel with the disk (upper or lower position), since the movement is always parallel to the face of the disk. On the contrary, with the present fixing to the rear part, the wheels tend to open, and this provides for entrance of the unwanted elements. However, fixing to the front part is not an innovation, since some seeders already include it.

The innovation herein basically consists of a kind of hinge mechanism (3), which in closed position causes attachment of the wheel to the disk and thus, the wheel remains perfectly attached through a lock designed for said function (4), and in open position, the wheel is separated from the disk (Drawings No. 2 and 3), and the area (larger) between the two may be cleaned.

Depth regulation is carried out by operating a square thread screw bolt (5), the articulated end of which (6) produces effect on the levers attached to the arms of the corresponding wheels. Said articulation of the end provides free and separate movement of both wheels of the system.

We shall describe the invention based on Patent Invention No. 250967, “Joint assembly of main arm and balance beam . . . ”, the mechanism of which is almost completely known, but including a new arrangement, as shown in Drawing No. 1, in which some of the elements of the seeding assembly or seeding train have been redesigned and redistributed.

Moreover, one of the novelties of the present invention consists of the hinge kind of mechanism (3) of Drawing No. 1 or Drawing No. 2, which operates the assembly and causes the wheel to attach to the disk and remain perfectly secured by a lock designed for such purpose.

On the other hand, the hinge kind of element provides, in open position, the necessary separation distance between the wheel and the disk, for the proper and prompt cleaning.

A further novelty in the improvement of this invention is that depth control is carried out by a screw bolt (5) shown in Drawings No. 1 and 2.

The use and practice of the seeding machinery which showed the inconveniences of the obstruction with residues encouraged to place and use the hinge kind of articulation, and the new arrangement of the assembly of depth control wheels, which naturally adapts itself to the movement by resting the wheel against the disk.

Thus, one of the manufacturing options has been reviewed, and thus the invention and its application have been defined, without limitation, the invention is in line with the specification, claims and attached drawings, which further describe the summary of the invention.

1. Seeding assembly in seeding machines including:
a. A device for furrow opening
b. A device for directing the seed into the furrow
c. A device for directing the fertilizer into the furrow
d. A device to control the depth of seeding
e. A device for furrow closing
f. A device to press the seed
characterized by being arranged in a position that provides higher efficiency of the depth control function, where regulation depends on a screw bolt that operates a lever attached to the arm of the depth control wheel, which in turn may swing in a hinge kind of mechanism, located in the front of the assembly.

2. Seeding assembly in seeding machines, according to claim 1, characterized by the fact that the hinge kind of mechanism, located in the front part, includes flat faces in both its articulated plates located parallel to the flat face of the respective furrow opening disk, being also a mobile plate and a fixed plate in reference to the balance beam.

3. Seeding assembly in seeding machines, according to claim 2, characterized by the fact that the hinge kind of mechanism, located in the front, includes attached to its mobile articulated plate a shaft where the arm of the depth control wheel swings, placed in such a way that whatever the regulation depth, the flat side face of the wheel is always separated by the same minimum distance from the corresponding furrow opening disk, since upward or downward movement thereof is parallel to the side face of the disk.

4. Seeding assembly in seeding machines, according to claim 3, characterized by including a manual locking mechanism on each side of the outer side faces of the balance beam, which fixes to its operative position the hinge kind of mechanism corresponding to each depth control wheel, operating the respective mobile articulated plate.

5. Seeding assembly in seeding machines, according to claim 4, characterized by the fact that the hinge kind of mechanism is arranged in the front of the assembly, joining the fixed articulated plate to the balance beam by a piece designed for said purpose.

6. Seeding assembly in seeding machines, according to claim 5, in which the depth regulation and articulation of the hinge mechanism is arranged in the front part of the assembly, in such a way that the forces produced by the seeding movement tend to press the depth control wheel against the furrow opening disk.

7. Seeding assembly in seeding machines, according to claim 6, in which regulation of the depth control wheel depends on a screw bolt located over the balance beam, which operates an articulated end, the side parts of which press or free the levers attached to the arms of the corresponding wheels, thus controlling the penetration depth of the furrow opening disks and providing free and separate movement to the wheels.

8. Seeding assembly in seeding machines, according to the foregoing claims, characterized by the fact that the hinge kind of mechanism is manually released by operating the lock, in such a way that the depth control wheel may swing with increasing angle respect to the furrow opening disk, to clean and/or repair, and with decreasing angle to place it close to the furrow opening disk, up to a final location in which it once more locks manually.

9. Seeding assembly in seeding machines, characterized by the fact that it is described by the foregoing claims and, without limitations, it is in line with the specification and drawings herein attached.
